(19) United States
(12) Patent Application Publication
(10) Pub. No.: US 2003/0105689 A1
(43) Pub. Date: Jun. 5, 2003

(54) Methods, systems and articles of manufacture for managing financial accounts with reward incentives

(76) Inventors: Sanjeev Kumar Chandak, Richmond, VA (US); Dan Guy Baker, Glen Allen, VA (US); Krishnamurthy Bindumadhavan, Richmond, VA (US); Deborah Amie Candeub, Arlington, VA (US); Lisa Michele Chancellor, Mechanicsville, VA (US); Brad Jiulianti, Boise, ID (US); William Joseph McSorley IV, Springfield, VA (US)

Correspondence Address: Finnegan, Henderson, Farabow,, Garrett & Dunner, L.L.P., 1300 I Street, N.W., Washington, DC, 20005-3315, US

(21) Appl. No.: 09/996,944

(22) Filed: Nov. 30, 2001

(51) Int. Cl. G06F 17/60

(52) U.S. Cl. 705/35

(57) ABSTRACT

Methods, systems, and articles of manufacture for providing a reward incentive credit card product is disclosed. Customers may be offered a reward incentive credit card product form a credit card issuer that allows the customer to accumulate reward points based on payments received by the credit card issuer. The reward points may be used to obtain consumer goods from the credit card issuer and/or third party vendors. The credit card issuer may adjust the number of reward points associated with the customer's account based on determined criteria and parameters including the amount of payment received by the credit card issuer and the timeliness of the payment. Based on an aggregated number of reward points accumulated by the customer, base don his/her payment activities, the customer may be provided with an indication reflecting consumer goods, such as goods and/or services, that the customer is eligible to obtain using the accumulated reward points.

### BACKGROUND OF THE INVENTION

I. Field of the Invention

This invention relates to financial account products and, more particularly, to systems, methods, and articles of manufacture for managing financial accounts with reward incentives.

II. Background and Material Information

Credit card products have become so universally well known and ubiquitous that they have fundamentally changed the manner in which financial transactions and dealings are viewed and conducted in society today. Credit card products are most commonly represented by plastic card-like members that are offered and provided to customers through credit card issuers (such as banks and other financial institutions). With a credit card, an authorized customer or cardholder is capable of purchasing services and/or merchandise without an immediate, direct exchange of cash. With each purchase, the cardholder incurs debt to their credit card account, which the cardholder may thereafter pay upon receipt of a periodic, for example, monthly, statement. In most cases, the cardholder will have the option to either fully pay the outstanding balance or, as a matter of necessity or choice, defer at least a portion or the balance for later payment with accompanying interest or finance charges for the period during which payment of the outstanding debt is deferred (also referred to as a revolving charge credit line).

In order to attract or retain customers, credit card issuers may offer credit card products that are associated with one or more incentives. These incentives may include points that are accumulated based on purchases made with these types of credit card products. A cardholder may use the accumulated points to receive goods and/or services provided by the credit card issuer and/or third party vendors. For example, credit card issuers may offer credit card products associated with refueling stations for vehicles, such as a franchised gas station. When a cardholder makes purchases at the franchised gas station, the credit card issuer may credit the cardholder's account with a certain number of points. These points may reflect a proportional amount of fuel the cardholder may receive from the franchised gas station. Other types of vendors have “teamed up” with credit card issuers to provide similar incentives, whereby a cardholder may receive goods and/or services proportional to a certain number of points credited to their account. For example, some financial accounts allow consumers to earn “frequent flier miles” with an airline company by making purchases with the financial account.

As can be seen, such cards provide more points or incentives to the cardholder as the more the cardholder purchases. Although these products have a high demand among customers, financial abuse of these products by some cardholders, such as overcharging and late payments, may cost a financial account issuer millions of dollars annually. For example, a cardholder's motivation to obtain points may sometimes supercede their motivation to make timely payments to a credit card issuer.

### SUMMARY OF THE INVENTION

Accordingly, there is a need for an improved method, system, and article of manufacture for providing a financial account associated with reward incentives that still motivates a customer to make timely payments to a financial account provider to receive the reward incentives.

Methods, systems, and articles of manufacture consistent with the principles of the present invention enable a financial account provider, such as a credit card issuer, to provide a financial account, such as a credit card account, that is associated with reward incentives. To provide the reward incentive account, the credit card issuer may group customers based on a risk value associated with each of the customer. The credit card issuer may then create separate offers for each group and provide each customer in these groups with an appropriate offer for a reward incentive account. A customer who accepts an offer may receive a reward incentive credit card product from the credit card issuer. The reward incentive credit card product may be associated with a reward incentive account managed by the credit card issuer.

Methods, systems, and articles of manufacture consistent with certain principles related to the present invention enable the credit card issuer to monitor the progress of the reward incentive account to determine whether payments have been received that meet a predefined criteria, such as the customer making a timely payment of a predetermined amount to the credit card issuer. In the event a customer meets the criteria, the credit card issuer may associate reward points with the reward incentive account based on the amount of payment received. In one configuration consistent with certain principles related to the present invention, the credit card issuer may determine whether the reward incentive account is associated with reward points that meet or exceed certain thresholds. Based on the threshold exceeded, the credit card issuer may provide the customer with an indication of types of reward incentives he/she is eligible to receive using their reward points.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments and aspects of the present invention and, together with the description, explain the principles of the invention. In the drawings:

FIG. 1 illustrates an exemplary system environment in which certain features and principles related to the present invention may be implemented;

FIG. 2 is a flowchart of an exemplary process for offering customers a reward incentive account, consistent with certain principles related to the present invention;

FIG. 3 is a flowchart of an exemplary process for processing responses from customers, consistent with certain principles related to the present invention; and

FIG. 4 is a flowchart of an exemplary point tracking process, consistent with certain principles related to the present invention.

### DETAILED DESCRIPTION

Generally, the present invention is directed to methods, systems, and articles of manufacture for providing reward incentive financial account products, such as credit card products, to customers that accumulate reward points based on one or more payments received at a financial account provider, such as a credit card issuer. A reward incentive financial account product may be used by a customer to purchase goods and/or services as may be done with standard financial accounts or credit card products. Furthermore, the reward incentive credit card product may also be associated with reward points that may be used by the customer to obtain consumer goods based on the amount of reward points. The reward points are accumulated based on an amount of payments received by the financial account provider for the reward incentive account. Therefore, a customer may accumulate reward points by making timely payments that are due to the financial account provider and eventually be eligible to obtain consumer goods based on the amount of reward points accumulated.

Reference will now be made in detail to the invention, examples of which are illustrated in the accompanying drawings. Wherever possible, the same reference numbers will be used throughout the drawings to refer to the same or like parts.

The above-noted features and other aspects and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

The present invention also relates to computer readable media that include program instruction or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

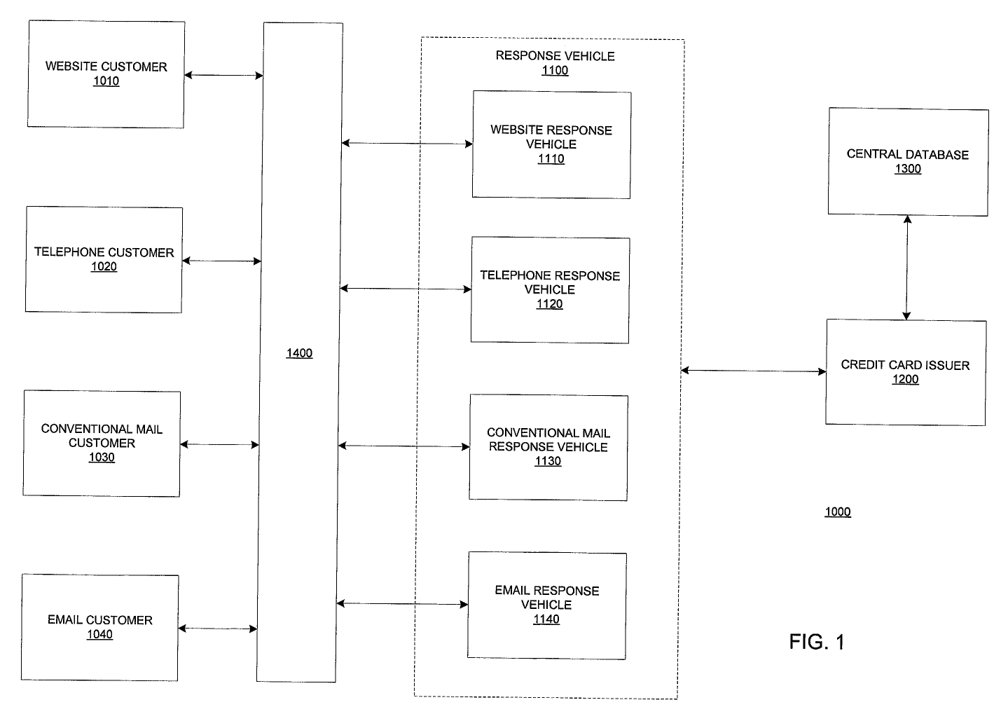

FIG. 1 illustrates an exemplary system environment 1000 in which the features and principles of the invention may be implemented. As illustrated in FIG. 1, the system environment 1000 includes a plurality of customers (consumers) (1010-1040), a response vehicle system 1100 including a plurality of different response vehicles (1110-1140), a credit card issuer 1200, a central database 1300, and a communications channel 1400. While systems, methods, and articles of manufacture consistent with the present invention are described herein with respect to credit cards, the present invention may be used for any type of financial account in which payments are made to an account issuer.

Each customer in system environment 1000 is associated with a different customer category. For instance, customer 1010 may be a Web site customer that accesses and retrieves information through a Web site on the World Wide Web of the Internet. The Web site may be a branded Web site operated by one or more vendors, or may be a Web site operated by a credit card issuer. Customer 1020 may be a telephone customer that accesses and receives information using conventional telephonic communication techniques and systems. This includes, for example, wireline and wireless telephony systems. Customer 1030 may be a conventional mail customer that accesses and receives information by conventional mail techniques and services. This includes, for example, a customer that is part of a credit card issuer's mailing list. Finally, customer 1040 may be a customer that accesses and receives information using electronic mail services. Customer 1010-1040 may also represent entities (such as an individual, a group of individuals, corporate entities, or any combination thereof) that hold credit card accounts with the credit card issuer 1200. The categories of customers illustrated in FIG. 1 are exemplary and should not be considered limiting. For example, a variety of different customer categories may also be implemented in environment 1000, such as customers using kiosk computers or personal digital assistants (PDAs).

Response vehicle 1100 represents a system for handling communications between the customers 1010-1040 and credit card issuer 1200. Response vehicle 1100 may be part of a credit card issuer's network and, as shown in FIG. 1, include a plurality of response vehicles 1110-1140 that correspond to different categories of customers 1010-1040. Each response vehicle is responsible for handling communications to and from customers based on each customer's category. For example, For example, website response vehicle 1110 may handle Internet related communications, such as web based transactions, between customer 1010 and credit card issuer 1200. Telephone response vehicle 1120 handles telephonic communications between the customer 1020 and credit card issuer 1200. Thus, in the event credit card issuer 1200 wishes to solicit customers telephonically, response vehicle 1120 includes the necessary systems to support such operations including, for example, operators and telecommunications equipment to communicate with customers 1020. Response vehicle 1130, on the other hand, includes the necessary systems and organizations to handle conventional mail processing to and from customers 1030. Response vehicle system 1140 includes the necessary systems and organizations to process electronic mail transactions with customers 1040. Response vehicle system 1100 may receive responses from the customers and forward them to credit card issuer 1200 for appropriate processing. Notifications to the customers also are performed from issuer 1200 to the customer through response vehicle 1100. The notifications may include, for example, messages indicating acceptance of a reward incentive credit card product offered by credit card issuer 1200. Furthermore, response vehicle 1100 may provide the reward incentive credit card products to accepted customers through an appropriate response vehicle, such as conventional mail response vehicle 1130.

Communication channel 1400 facilitates communications between the various customers and response vehicle system 1100 illustrated in FIG. 1. Such communications may include communications related to offering and issuing lines of credit to selected customers. Communications channel 1400 may include, for example, a conventional mail distribution network such as that provided by the U.S. Postal Service, a telephony-based network, a local area network (LAN), a wide area network (WAN), a dedicated intranet, the Internet, and/or a wireless network. Further, any suitable combination of wired and/or wireless components and systems may be incorporated into communications channel 1400. Any suitable combination of point-to-point communications or networked communications may also be incorporated into communication channel 1400 to facilitate communication between the different entities illustrated in FIG. 1. Moreover, any part of communication channel 1400 may implemented through traditional infrastructures or channels of trade, to permit operations associated with credit card offers to be performed manually or in-person by the various entities illustrated in FIG. 1.

Credit card issuer 1200 receives communication information from response vehicle system 1100 and processes it using central database 1300. Database 1300 may contain various information including credit information, potential customer lists, risk scores for potential and current customers, approved customers, credit limits for approved customers, customer information, purchase information, authorization information, and/or settlement information. Issuer 1200 also sends information to response vehicle system 1100 for delivery to the appropriate customers. Credit card issuer 1200 is responsible for providing various credit cards and establishing associated accounts. Credit card issuer 1200 may include one or more of the following: a bank, an acquiring bank, a merchant bank, a merchant or any commercial institution capable of providing a financial account, such as a credit card account, consistent with the features disclosed herein. Further, although FIG. 1 only illustrates one credit card issuer 1200, it is of course possible that more than one credit card issuer be provided in system environment 1000.

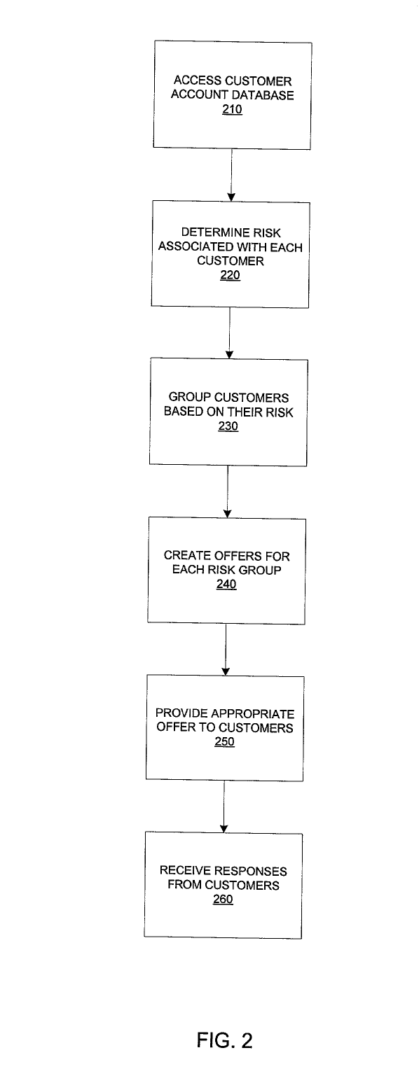

FIG. 2 illustrates an exemplary process associated with providing offers to customers for reward incentive credit card products consistent with certain principles related to the present invention. Although the present invention is described with reference to credit card products, one skilled in the art would realize that the present invention may be applied with any type of financial account and/or products without departing from the scope of the invention.

According to one aspect of the invention, credit card issuer 1200 may access a customer account database located in central database 1300 (Step 210). The customer account database may include financial account information associated with each customer of credit card issuer 1200. The financial account information may include, for example, credit card account data, such as account numbers and account parameters for each credit line associated with a customer (i.e., interest rates, credit limits, terms and conditions). The financial account information may also include payment history information and personal financial information, such as annual income, debts and assets, etc for customers of credit card issuer 1200. The customer account database may also include financial information of potential customers of credit card issuer 1200. A potential customer may be an individual who may not have a credit card account with credit card account, but may be targeted as an individual whom credit card issuer 1200 may want to offer a reward incentive credit card product.

Once the customer account database is accessed, credit card issuer 1200 may determine a financial risk value associated with each customer in the account database (Step 220). A customer's financial risk value may be associated with a risk that the customer may have potential for making late payments and overcharging a financial account based on past payment history data. Also, a customer's financial risk value may be associated with the customer's income and debts. Credit card issuer 1200 may consider several factors when determining a financial risk value for a customer. Such factors may be based on credit information received from one or more credit information sources (i.e., sources that provide credit information to credit card issuer 1200). Credit information may also be provided to credit card issuer 1200 when customers respond to credit card offers from issuer 1200. Moreover, credit information may be requested by issuer 1200 directly to a customer in previous solicitations. Credit information may include credit history information and/or personal information (e.g., income, employment status, etc.) that is used when evaluating a customer's credit worthiness. Credit information sources may comprise commercial credit information source (such as TRW/Experian, Equifax and TransUnion or a similar commercial credit service bureau) and/or private credit information services. Credit information sources may also represent credit information that was provided by customers, such as when a customer applied for an existing credit card.

In one configuration consistent with certain principles related to the present invention, credit card issuer 1200 may group customers based on their determined risk value (Step 230). Accordingly, customers with similar financial risk values may be grouped together and credit card issuer 1200 may generate offers for a reward incentive credit card product based on the different groups of customers (Step 240). For example, credit card issuer 1200 may allocate customer to one of four groups based on each customer's financial risk value. The first group may be associated with customers whose financial risk values are the highest among the four groups, while the fourth group may be associated with customers whose financial risk values are the lowest. Accordingly, credit card issuer 1200 may generate an offer for a customer in the first group for a reward incentive credit card product that includes terms and conditions different than those associated with an offer for a customer in the second through fourth groups.

In addition to various credit limits and interest rates associated with an offered reward incentive credit card product, credit card issuer 1200 may adjust the type of reward incentive parameters that may be associated with an offered credit card product. In one configuration consistent with certain principles related to the present invention, a customer with a high financial risk value may be offered a reward incentive account that includes a reward parameter that awards X (i.e., 15) number of reward points for every one dollar of payment received by credit card issuer 1200. A low financial risk customer, however, may be offered a reward incentive account including a reward parameter that awards a lower number of reward points for every dollar of payment receive by credit card issuer 1200, such as X-10 (i.e., 5 points). One skilled in the art would realize that the types of a reward parameters offered by credit card issuer 1200 may vary and is not limited to the above example. For instance, credit card issuer 1200 may take into consideration predetermined criteria to adjust the number of reward points that may be awarded to a customer. Such criteria may include the timeliness of payments received by credit card issuer 1200 (i.e., reducing the number of reward points for late payments, and/or adding reward points for payments received before a due date) and the amount of a received payment in relation to a minimum payment due to credit card issuer 1200. Furthermore, one skilled in the art would realize that credit card issuer 1200 may implement one or more criteria to determine the amount of reward points to associate with a reward incentive account.

Once the reward incentives offers are created, credit card issuer 1200 may send the offers to response vehicle system 1100 for distribution to respective customers (Step 250). Each response vehicle in vehicle 1100 processes the offers in order to provide them to the customers through communication channel 1400. For instance, response vehicle 1110 formulates offers for generation and viewing on one or more Web sites. The Web sites may be associated with a card issuer's Web site or sites that are operated by selected vendors. Once each response vehicle has processed the offers, they are sent to the specified customers for response. Customers 1010-1040 may respond (accept or decline) to the offers using the medium associated with their category. The responses are sent back to response vehicle system 1100, where they are processed for presentation to card issuer 1200 (Step 260).

Based on the category of a customer, responses may or may not be processed immediately. For instance, responses may be received and processed instantaneously and/or automatically for customers 1010 and 1020, while responses from customers 1030 may be delayed. For example, suppose a customer 1010 using a personal computer views a Web site operated by issuer 1200. The site may include a designated page that presents the customer with the reward incentive offer determined by issuer 1200. The customer may decide to accept or decline the offer by merely selecting an icon representing their choice and perhaps providing financial information through the Web site. The response is then sent back to response vehicle 1110. Response vehicle 1110 processes the response and prepares it for presentation to card issuer 1200. The response is processed at card issuer 1200 and a notification may be sent back to customer 1010 through response vehicle 1110. The notification may indicate to the customer that their response to an offer has been processed and their acceptance to receive a reward incentive credit card product from credit card issuer 1200. The notifications may be displayed through a Web page that the customer was viewing when the offer was presented or on a separate Web page. In one configuration consistent with the present invention, the customer may check the Web page to receive the notification. Alternatively, credit card issuer 1200 may provide an e-mail to the customer including the notification or a message indicating to the customer to check a particular Web site to receive the notification.

As can be seen, a customer who has accepted an offer through a Web site may receive immediate notification of an approval for an advantage credit card provided by credit card provider 1200. On the other hand, a customer who has been solicited by conventional mail, such as customer 1030, may respond to the offer by mailing back an acceptance form to the card issuer. The acceptance form may be received and processed by response vehicle 1130, and eventually processed by credit card issuer 1200. Notification of an acceptance by credit card issuer 1200 may then be sent back to the customer using the same conventional mail process.

There may be a plurality of variations available to card issuer 1200 when communicating with customers. That is, a mail customer 1030 may wish to respond by telephone or through a Web site. Additionally, customers may respond by one medium, and request notification by another. For instance, a customer 1030 who has received an offer in the mail, may respond by mail, yet request notification by email. Accordingly, a variety of user friendly options are available to customers for receiving and responding to the offers presented by card issuer 1200. The above descriptions are for illustration purposes alone and should not be viewed as limitations to the present invention. One of ordinary skill in the art would realize that any number of combinations of communication techniques may be implemented without departing from the principles of the present invention.

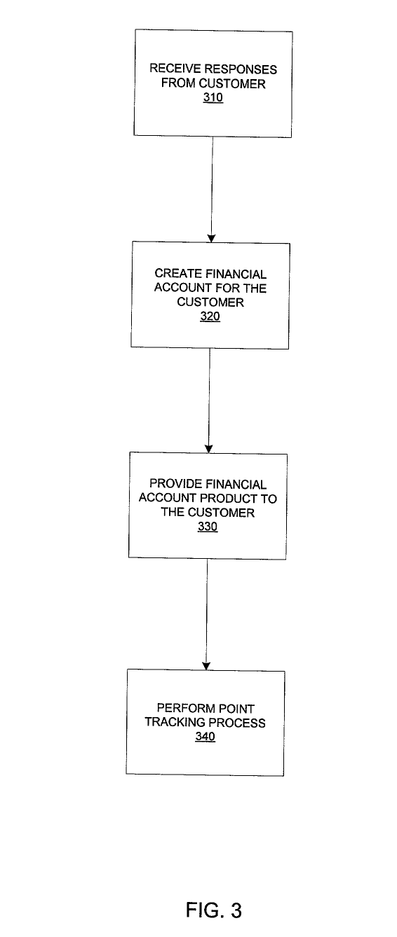

FIG. 3 illustrates an exemplary process that may be performed by credit card issuer 1200 when processing a customer's acceptance to an offer described with respect to FIG. 2. As shown, credit card issuer 1200 may receive a response from a customer indicating their acceptance to receive a reward incentive credit card product from credit card issuer 1200 (Step 310). In one configuration consistent with certain principles related to the present invention, the response may include financial information provided by the customer. Credit card issuer 1200 may use this information to determine a credit worthiness for the customer to determine the customer's eligibility to receive a reward incentive credit card product. This configuration may be useful where the customer's financial information may have changed since credit card issuer 1200 determined a financial risk value for the customer as part of step 220. In the event the customer's financial information has changed such that credit card issuer 1200 deems the customer ineligible to receive a reward incentive credit card product, credit card issuer 1200 may notify the customer of ineligibility through response vehicle 1100.

Referring back to FIG. 3, credit card issuer 1200 may create a reward incentives financial account for the customer (Step 320). Creating such an account may include providing an account segment in central database 1300 for the customer. The segment may include financial account parameters associated with the created account, such as fields including data associated with an account number, customer identification information, interest rates for one or more lines of credit associated with the account, penalty fee amounts and associated terms and conditions for receiving a penalty fee, a credit limit for each line of credit associated with the account, and any other financial account parameter information known in the art. In addition to these parameters, credit card issuer 1200 may also include reward incentive parameters associated with the customer's account. The reward incentive parameters may include, but are not limited to, a reward point distribution parameter, a total reward point parameter, a reward incentive time penalty parameter, a reward incentive time bonus parameter, reward point payment bonus parameter, a reward point payment penalty parameter, and an aggregate reward point parameter.

The reward point distribution parameter may be a value that determines the number of reward point(s) that are to be associated with the reward incentive account for each predetermined amount of payment received by credit card issuer 1200. For example, the reward point distribution parameter may be a value reflecting a ratio between a received payment and reward points. The total reward point parameter may reflect a total number of reward points that are associated with the account based on a particular payment received and the reward point distribution parameter. The reward incentive time penalty parameter may reflect may reflect the amount of reward points that are to be subtracted from the customer's reward points (included in the total reward point parameter) when credit card issuer 1200 receives a late payment for the customer's account. The reward incentive time bonus parameter may reflect the amount of reward points that are to be added to the customer's reward points (included in the total reward point parameter) when credit card issuer 1200 receives an early payment for the customer's account. The reward point payment bonus parameter may reflect the amount of reward points that may be added to the customer's reward points (that may be included in the total reward point parameter) based on an amount of payment received above a minimum payment set by credit card issuer 1200. The reward point payment penalty parameter may reflect the amount of reward points that may be subtracted from the customer's reward points (that may be included in the total reward point parameter) based on an amount of payment received below a minimum payment set by credit card issuer 1200. The aggregate reward point parameter may reflect the customer's aggregate number of reward points associated with the customer's account based on previous payments received by credit card issuer 1200 for the customer's account. One skilled in the art would realize that the reward incentive parameters described above are exemplary and not intended to be limiting. Credit card issuer 1200 may implement one or more these and other reward incentive parameters to comply with their business goals and plans.

One the reward incentive account has been created and the appropriate parameters set, credit card issuer 1200 may create and provide a reward incentive credit card product to the customer (Step 330). Afterwards, credit card issuer 1200 may perform a point tracking process consistent with certain principles related to the present invention (Step 340).

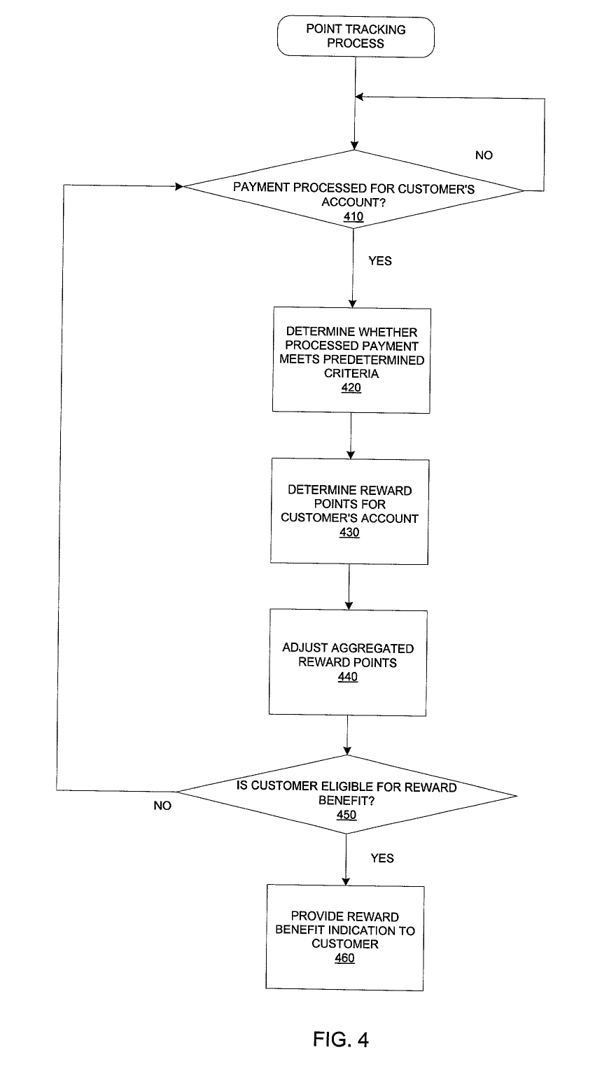

FIG. 4 shows a flowchart of an exemplary point tracking process that may be executed by a processor within credit card issuer 1200, consistent with certain principles related to the present invention. The point tracking process may begin by credit card issuer 1200 determining whether an appropriate payment for the customer's account has been received and processed by credit card issuer 1200 (Step 410). If not (Step 410; NO), the point tracking process returns to repeat this step until a payment is received and processed. On the other hand, if a payment has been received and processed (Step 410; YES), credit card issuer 1200 may determine whether the processed payment meets reward incentive criteria associated with the customer's account (Step 420). A processed payment may meet incentive criteria based on the parameters associated with the customer's account. For example, criteria such as minimum payment, timeliness of payment, and overcharging may be considered by credit card issuer 1200 when determining whether the processed payment has met the criteria. Once the processed payment is analyzed against the criteria set for the customer's account, credit card issuer 1200 may determine the amount of reward points to associated with the customer's account based on the determination performed in Step 420 (Step 430).

In one configuration consistent with certain principles related to the present invention, credit card issuer 1200 may determine the total reward points to be included in the total reward point parameter based on the reward point distribution parameter and the amount of payment received and processed by credit card issuer 1200. For example, suppose a reward point distribution parameter indicates that the customer's account is to receive 10 reward points for every dollar of payment (which may be rounded to the nearest dollar value) received by credit card issuer 1200. Further, suppose that credit card issuer 1200 received a payment of $200. Based on this example, credit card issuer 1200 may include 200×10, or 2,000 points in the total reward point parameter.

Credit card issuer 1200 may also make adjustments to the number of reward points included in the total reward point parameter based on other reward incentive parameters associated with the customer's account and the determination performed in Step 420. For example, if in Step 420, credit card issuer 1200 determined that a payment was received late, credit card issuer 1200 may adjust the number of reward points in the total reward point parameter based on the reward incentive time penalty parameter. For instance, using the example above, the 2,000 points included in the total reward point parameter may be reduced by credit card issuer 1200 by a predetermined percentage, or point amount based on the reward incentive penalty parameter (e.g., 10% for every day late, up to 100%, or 10 points for every day late, etc.). On the other hand, if the payment was received some time before a determined due date, the number of reward points included in the total reward point parameter may be increased by credit card issuer 1200 an amount reflected by the reward incentive time bonus parameter. For instance, again using the example above, credit card issuer 1200 may increase the 2,000 points included in the total reward point parameter by 10 points for every week the payment is received before the determined due date. Furthermore, credit card issuer 1200 may adjust the number of points in the total reward point parameter by the amount of the received payment relative to a required minimum payment amount. Again using the example above, credit card issuer 1200 may increase the 2,000 points included in the total reward point parameter by 5 points for every $25 of payment above a minimum payment that is due. Alternatively, credit card issuer 1200 may reduce the 2,000 points by 50 points for every $10 the received payment is below the minimum payment based on the reward point payment penalty parameter. One skilled in the art would realize that the examples described above are not intended to be limiting and methods, systems, and articles of manufacture consistent with certain principles related to the present invention may incorporate any combination of reward incentive parameters, or none at all, to adjust the number of reward points included in the total reward point parameter.

Returning back to FIG. 4, once credit card issuer 1200 has determined and adjusted the total reward points for the customer's account based on the reward incentive parameters, the aggregate reward point parameter may be adjusted (Step 440). For example, if the total reward point parameter, after any adjustments made by credit card issuer 1200, is 1,000 points and the aggregate reward point parameter is 20,000 points, credit card issuer 1200 may adjust the 20,000 points to a new value of 21,000 points. In one configuration consistent with certain principles related to the present invention, credit card issuer 1200 may allow the total reward point parameter to be a negative number, based on any penalty parameters associated with the customer's account. In this configuration, the number of reward points in the aggregate reward point parameter may be reduced by this negative value, thus providing an additional penalty to the customer's account based on undesirable payment activities associated with the customer's account (i.e., late payments, overcharges etc.).

Following the adjustments of the aggregate reward point parameter, credit card issuer 1200 may determine whether the customer's account is eligible for a reward benefit based on the number of points included in the aggregate reward point parameter (Step 450). This determination may be based on the types of consumer goods that are offered by either credit card issuer 1200 and/or third party vendors that accept the reward points issued by credit card issuer 1200. Consumer goods may include goods and/or services that are provided by an entity, such as travel services provided by an airline and items offered by a department store. For example, credit card issuer 1200 may maintain a database that includes a list of all of the consumer goods that are offered by credit card issuer 1200 and any third party vendor that accepts the reward points issued by credit card issuer 1200. The list may include various consumer goods offered and the number of reward points required by a customer to obtain them. Credit card issuer 1200 may analyze the list and the number of points included in the aggregate reward point parameter to determine the types of consumer goods the customer may be eligible to receive.

In the event the customer is not eligible to receive any consumer goods (Step 450; NO), the point tracking process returns to Step 410 to await the next processed payment by credit card issuer 1200. If credit card issuer 1200 determines that the customer's account is eligible for one or more rewards benefits based on the aggregate reward point parameter (Step 450; YES), a reward benefit indication may be created and provided to the customer through response vehicle 1100 (Step 460). In one configuration consistent with certain principles related to the present invention, the reward benefit indication may identify the types of consumer goods the customer is eligible to receive and the identity of the provider of these consumer goods. Alternatively, credit card issuer 1200 may also include in the reward benefit an indication of consumer goods that the customer may be eligible to obtain with an additional number of reward points. For example, the indication may include a message reflecting that the customer may obtain one or more items with an additional 2,000 points. Once the reward benefit indication is provided to the customer, the point tracking process may return to Step 410 to await another processed payment by credit card issuer 1200.

As described, methods, systems, and articles of manufacture consistent with certain principles related to the present invention enable a credit card customer to receive a credit card product from a credit card issuer 1200 that enables the customer to accumulate reward points based on payments made to credit card issuer 1200. The reward points may be associated with consumer goods that may be obtained by the customer. The credit card issuer 1200 may manage the credit card product by adjusting the number of reward points based on the amount of a received payment and/or the timeliness of the payment. Accordingly, the credit card issuer 1200 provides a credit card product that includes incentives to a customer to make timely and appropriate payments to the credit card issuer 1200 in return for consumer goods that may be provided by the credit card issuer or one or more third party vendors.

Although the present invention has been described based on the system environment 1000 shown in FIG. 1, one skilled in the art would realize that various other configurations may be employed by methods, systems, and articles of manufacture consistent with certain principles related to the present invention without affecting its scope. Furthermore, the types of reward parameters and their use in the point tracking process described in FIG. 4, may be adjusted to meet the needs of the credit card issuer and its customers, without departing from the spirit and scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, the process steps shown in FIGS. 2-4 are not limited to the sequences described above. Variations of these sequences, such as the removal and/or the addition of other process steps may be implemented without departing from the spirit and scope of the present invention. For example, in one configuration consistent with certain principles related to the present invention, credit card issuer 1200 may adjust an account's reward point distribution parameter based on changes to a corresponding customer's financial risk value. In this configuration, credit card issuer 1200 may perform periodic financial risk assessments for each of its reward incentive credit cardholders. Based on a change in financial risk associated with a customer, the amount of reward points per dollar of received payment may be adjusted by credit card issuer 1200. For example, suppose a high credit risk customer of a reward incentives credit card has an initial reward point distribution parameter that allows the customer's account to obtain 20 points for each dollar of payment received by credit card issuer 1200. The distribution parameter may be adjusted by credit card issuer 1200 to reflect that the customer's account will obtain 10 points per dollar of received payment based on a determination that the customer's financial risk has decreased (the customer is now less of a financial risk to credit card issuer 1200 and thus less incentives is needed for the customer to make a payment). One skilled in the art would realize that the distribution parameter may be adjusted to increase the number of reward points received per dollar of received payment as well. Furthermore, the adjustment of the distribution parameter may be used by credit card issuer 1200 to increase or decrease the number of reward points obtained per predetermined amount of received payment based on either an increase or decrease in financial risk associated with the customer to credit card issuer 1200. Also, the proportion of reward points that may be associated with a customer's account may be based on various increments of received payment amounts, such as X points for every $1, $5, $10, $50, etc. without departing from the scope of the present invention.

Additionally, the present invention may be applied to financial accounts other than credit card accounts. Any financial institution that provides financial accounts to customers may employ methods, systems, and articles of manufacture consistent with certain principles related to the present invention. For example, a bank which provides financial loans to customers may offer a reward incentive plan whereby the customer's financial account may receive reward points based on payments received by the bank.

Furthermore, although aspects of the present invention are described as being associated with data stored in memory and other storage mediums, one skilled in the art will appreciate that these aspects can also be stored on or read from other types of computer-readable media, such as secondary storage devices, like hard disks, floppy disks, or CD-ROM; a carrier wave from the Internet; or other forms of RAM or ROM. Accordingly, the invention is not limited to the above described embodiments, but instead is defined by the appended claims in light of their full scope of equivalents

What is claimed is:

1. A method for managing a financial account for a consumer, comprising:
providing the financial account to the consumer, wherein the financial account is associated with a reward incentive parameter indicating a predetermined amount of reward points that will be associated with the financial account based on a predetermined payment amount to the account;
receiving a payment for a particular amount to the financial account; and
determining an amount of reward points to associate with the financial account based on the reward incentive parameter and the received payment amount, wherein the determined amount of reward points can be used to receive a consumer good.

2. The method of claim 1, wherein determining an amount of reward points further comprises:
determining whether the received payment amount is below a minimum payment amount.

3. The method of claim 2, wherein determining an amount of reward points further comprises:
reducing the amount of reward points based on a determination that an amount of the received payment is below the minimum payment amount.

4. The method of claim 2, wherein determining an amount of reward points further comprises:
reducing the amount of reward points based on a determination that the received payment was received after a payment due date.

5. The method of claim 2, wherein determining an amount of reward points further comprises:
increasing the amount of reward points based on a determination that an amount of the received payment is above the minimum payment amount.

6. The method of claim 2, wherein determining an amount of reward points further comprises:
increasing the amount of reward points based on a determination that an amount of the received payment is received before a payment due date.

7. The method of claim 1, wherein determining an amount of reward points further comprises:
determining the amount of reward points to associate with the financial account based on an amount of the received payment and a reward distribution parameter.

8. The method of claim 7, wherein the reward distribution parameter is based on a financial risk associated with a customer corresponding to the financial account.

9. The method of claim 8, wherein the reward distribution parameter is adjusted based on a change in the financial risk associated with the customer.

10. The method of claim 1, further comprising:
determining whether a customer corresponding to the financial account is eligible for one or more consumer goods based on a total amount of reward points associated with the financial account; and
providing an indication to the customer reflecting a result of the determining whether the customer is eligible for one or more consumer goods.

11. A system for managing a financial account for a consumer, comprising:
means for providing the financial account to the consumer, wherein the financial account is associated with a reward incentive parameter indicating a predetermined amount of reward points that will be associated with the financial account based on a predetermined payment amount to the account;
means for receiving a payment for a particular amount to the financial account; and
means for determining an amount of reward points to associate with the financial account based on the reward incentive parameter and the received payment amount, wherein the determined amount of reward points can be used to receive a consumer good.

12. The system of claim 11, wherein the means for determining an amount of reward points further comprises:
means for determining whether the received payment amount is below a minimum payment amount.

13. The system of claim 12, wherein the means for determining an amount of reward points further comprises:
means for reducing the amount of reward points based on a determination that an amount of the received payment is below the minimum payment amount.

14. The system of claim 12, wherein the means for determining an amount of reward points further comprises:
means for reducing the amount of reward points based on a determination that the received payment was received after a payment due date.

15. The system of claim 12, wherein the means for determining an amount of reward points further comprises:
means for increasing the amount of reward points based on a determination that an amount of the received payment is above the minimum payment amount.

16. The system of claim 12, wherein the means for determining an amount of reward points further comprises:
means for increasing the amount of reward points based on a determination that an amount of the received payment is received before a payment due date.

17. The system of claim 11, wherein the means for determining an amount of reward points further comprises:
means for determining the amount of reward points to associate with the financial account based on an amount of the received payment and a reward distribution parameter.

18. The system of claim 17, wherein the reward distribution parameter is based on a financial risk associated with a customer corresponding to the financial account.

19. The system of claim 18, wherein the reward distribution parameter is adjusted based on a change in the financial risk associated with the customer.

20. The system of claim 11, further comprising:
means for determining whether a customer corresponding to the financial account is eligible for one or more consumer goods based on a total amount of reward points associated with the financial account; and
means for providing an indication to the customer reflecting a result of the determining whether the customer is eligible for one or more consumer goods.

21. A computer-readable medium including instructions for performing a method, when executed by a processor, for managing a financial account for a consumer, the method comprising:
providing the financial account to the consumer, wherein the financial account is associated with a reward incentive parameter indicating a predetermined amount of reward points that will be associated with the financial account based on a predetermined payment amount to the account;
receiving a payment for a particular amount to the financial account; and
determining an amount of reward points to associate with the financial account based on the reward incentive parameter and the received payment amount, wherein the determined amount of reward points can be used to receive a consumer good.

22. The computer-readable medium of claim 21, wherein determining an amount of reward points further comprises:
determining whether the received payment amount is below a minimum payment amount.

23. The computer-readable medium of claim 22, wherein determining an amount of reward points further comprises:
reducing the amount of reward points based on a determination that an amount of the received payment is below the minimum payment amount.

24. The computer-readable medium of claim 22, wherein determining an amount of reward points further comprises:
reducing the amount of reward points based on a determination that the received payment was received after a payment due date.

25. The computer-readable medium of claim 22, wherein determining an amount of reward points further comprises:
increasing the amount of reward points based on a determination that an amount of the received payment is above the minimum payment amount.

26. The computer-readable medium of claim 22, wherein determining an amount of reward points further comprises:
increasing the amount of reward points based on a determination that an amount of the received payment is received before a payment due date.

27. The computer-readable medium of claim 21, wherein determining an amount of reward points further comprises:
determining the amount of reward points to associate with the financial account based on an amount of the received payment and a reward distribution parameter.

28. The computer-readable medium of claim 27, wherein the reward distribution parameter is based on a financial risk associated with a customer corresponding to the financial account.

29. The computer-readable medium of claim 28, wherein the reward distribution parameter is adjusted based on a change in the financial risk associated with the customer.

30. The computer-readable medium of claim 21, the method further comprising:
determining whether a customer corresponding to the financial account is eligible for one or more consumer goods based on a total amount of reward points associated with the financial account; and
providing an indication to the customer reflecting a result of the determining whether the customer is eligible for one or more consumer goods.
